(19) United States
(12) Patent Application Publication
(10) Pub. No.: US 2018/0167000 A1
(43) Pub. Date: Jun. 14, 2018

(54) RECTIFIER DEVICE

(71) Applicant: Infineon Technologies AG, Neubiberg (DE)

(72) Inventors: Albino Pidutti, Martignacco (IT); Damiano Gadler, Villach (AT); Herbert Gietler, Villach (AT); Michael Lenz, Zorneding (DE)

(21) Appl. No.: 15/378,945

(22) Filed: Dec. 14, 2016

(51) Int. Cl. H02M 7/219; H02M 1/32

(52) U.S. Cl. CPC H02M 7/219; H02M 1/32

(57) ABSTRACT

A rectifier device is described herein. In accordance with one example, the rectifier device includes a transistor that has a load current path and a diode connected parallel to the load current path. The diode and the load current path are connected between an anode terminal and a cathode terminal; an alternating input voltage is operably applied between the anode terminal and the cathode terminal. A control circuit is coupled to a gate terminal of the transistor and configured to switch the semiconductor switch on for an on-time period, during which the diode is forward biased. Moreover, a clamping circuit is coupled to a gate terminal of the transistor and configured to at least partly switch on the transistor, while the diode is reverse biased and the level of the alternating input voltage reaches a clamping voltage.

### TECHNICAL FIELD

The invention relates to the field of power supplies, in particular to rectifier circuits and devices and related methods and devices.

### BACKGROUND

In the electric power grid electric electricity is usually distributed to customers in the form of alternating current (AC) for various reasons. Furthermore, alternators are used, for example, in automobiles to generate alternating current. In many applications, alternating current has to be converted into direct current (DC) in order to provide a DC supply for electronic circuits or other devices, which need a DC supply. This conversion process is referred to as rectification. The standard components used to build a rectifier are silicon diodes. Several types of rectifier exists. One common type is a single-phase full-wave rectifier that is usually built using four diodes connected in a bridge configuration (a so-called Graetz bridge). As a side note, it should be mentioned that the alternating voltage provided by the electric power grid (e.g. 120 or 230 volts) is usually transformed to lower voltages using transformers before being rectified. In the automotive sector, alternators usually generate multiple-phase output voltages, and, for example, a three-phase full-wave rectifier includes six diodes. Furthermore, rectifier diodes may also be used, for example, in (DC/DC or AC/DC) switching converters.

Silicon diodes have a forward voltages of approximately 0.6 to 0.7 volts. Schottky- and germanium diodes have slightly lower forward voltages of approximately 0.3 volts. The forward voltage of a pn-junction (i.e. of a diode) depends on the semiconductor material and therefore can be regarded practically as a constant parameter for a specific semiconductor manufacturing technology, which normally is based on silicon. It is understood, however, that the actual forward voltage is temperature dependent. That is, silicon diodes will always produce a power dissipation of approximately 600 to 700 milliwatts per ampere load current. A diode bridge (bridge rectifier), which is composed of four diodes, thus produces a power dissipation of approximately 1.2 to 1.4 watts per ampere (RMS) of load current as two diodes are always forward biased in a diode bridge. Particularly for comparably low voltages (e.g. 5 to 15 volts) the power dissipation in the rectifier can be a significant portion of the total power consumption.

To reduce power dissipation in rectifier devices, a technique referred to as active rectification may be used. Thereby, silicon diodes are replaced by power transistors such as power MOS field effect transistors (MOSFETs) or power bipolar junction transistors (BJTs), which have a comparably low on-resistance and thus may produce a significantly lower voltage drop as compared to simple silicon diodes. However, usually a relatively complex control circuit is needed to switch the transistor on and off synchronously to the alternating voltage.

In applications, in which a rectifier is operated with an alternator, the rectifier should have a clamping functionality (e.g. like a Zener diode) to avoid an over-voltage between the battery terminals in order to protect the loads supplied by the battery. This may be the case, for example, when the automotive battery is disconnected from the alternator while the loads remain connected to the alternator.

### SUMMARY

A rectifier device is described herein. In accordance with one example, the rectifier device includes a transistor that has a load current path and a diode connected parallel to the load current path. The diode and the load current path are connected between an anode terminal and a cathode terminal; an alternating input voltage is operably applied between the anode terminal and the cathode terminal. A control circuit is coupled to a gate terminal of the transistor and configured to switch the semiconductor switch on for an on-time period, during which the diode is forward biased. Moreover, a clamping circuit is coupled to a gate terminal of the transistor and configured to at least partly switch on the transistor, while the diode is reverse biased and the level of the alternating input voltage reaches a clamping voltage.

In accordance with a further example, the rectifier device includes a plurality of transistor cells integrated in a semiconductor body, wherein a first group of transistor cells are assigned to a first transistor and a second group of transistor cells are assigned to a second transistor. An anode and a cathode terminal or the rectifier device are connected by load current paths of the first transistor and the second transistor, and a diode is arranged in the semiconductor body between the anode and the cathode terminal. Further, a clamping circuit is arranged in the semiconductor body and coupled between a gate terminal of the first transistor and the cathode terminal. Transistor cells of the first group are arranged in first segments of the semiconductor body and the transistor cells of the second group are arranged in second segments of the semiconductor body.

Furthermore, a method for operating a rectifier device is described herein. In accordance with one example the rectifier device includes a first transistor and a second transistor and a diode coupled in parallel between an anode terminal and a cathode terminal, and the method includes: detecting when the diode is forward biased and switching on the first and the second transistor upon detection that the diode is forward biased, and switching off the first and the second transistor before the diode becomes again reverse biased. The method further includes monitoring, by a clamping circuit, a voltage between the cathode terminal and the anode terminal. The first transistor is switched on, when the diode is reverse biased and the voltage between the cathode terminal and the anode terminal reaches a clamping voltage, while the second transistor remains off.

Moreover, a rectifier bridge is described herein. In accordance with one example, the rectifier bridge includes a plurality of rectifier devices, wherein each of the rectifier devices has an anode terminal and a cathode terminal. Further, the rectifier devices include a transistor having a load current path and a diode connected parallel to the load current path between the anode terminal and the cathode terminal, wherein an alternating input voltage is operably applied between the anode terminal and the cathode terminal. A control circuit is coupled to a gate terminal of the transistor and configured to switch the semiconductor switch on for an on-time period, during which the diode is forward biased, and a clamping circuit is coupled to gate terminal of the transistor and configured to at least partly switch on the transistor while the diode is reverse biased and the level of the alternating input voltage reaches a clamping voltage.

### BRIEF DESCRIPTION OF THE DRAWINGS

The invention can be better understood with reference to the following description and drawings. The components in the figures are not necessarily to scale, emphasis instead being placed upon illustrating the principles of the invention. Moreover, in the figures, like reference numerals designate corresponding parts. In the drawings:

FIG. 1 illustrates, as an illustrative example, a three-phase full-wave rectifier circuit composed of six diodes connected to a three-phase alternator.

FIG. 2 illustrates a power MOSFET which can be used to replace a diode in a rectifier circuit, wherein, in the embodiments described herein, the power MOSFET is reverse conducting when switched on.

FIG. 3 is a cross-sectional view of a semiconductor body illustrating exemplary implementation of the power MOSFET of FIG. 2.

FIG. 4 is a circuit diagram illustrating the power MOSFET of FIG. 2 and a control circuit that is configured to actively switch the MOSFET on when the body diode becomes forward biased.

FIG. 5 is a timing diagram illustrating the voltage across the body diode of the MOSFET of FIG. 4, when the MOSFET is connected to a load and not actively switched on while being supplied with an alternating voltage.

FIG. 6 is a circuit diagram illustrating an exemplary supply circuit, which may be included in the control circuit to generate an internal supply voltage.

FIGS. 7A and 7B are timing diagrams illustrating one example of how the MOSFET of FIG. 4 may be switched on and off, when supplied with an alternating voltage.

FIG. 8 corresponds to the circuit of FIG. 4 with an additional clamping circuit and with more details of the control circuit.

FIG. 9 is a timing diagram illustrating the clamping functionality of the rectifier circuit of FIG. 8.

FIG. 10 is a diagram illustrating the temperature dependency of the characteristic curve of a Zener diode.

FIG. 11 is a diagram illustrating the temperature dependency of the characteristic curve of a rectifier device including a MOSFET and a clamping circuit with a Zener diode.

FIG. 12 is a diagram illustrating the temperature dependency of the characteristic curve of a MOSFET.

FIG. 13 illustrates a modification of the rectifier device of FIG. 8 with improved thermal stability, wherein the MOSFET is subdivided into two transistors.

FIG. 14 illustrates the distribution of the transistor cells of the two transistors of FIG. 12 throughout the semiconductor body.

FIG. 15 illustrates the assignment of the transistor cells to different segments of the chip area.

FIG. 16 is a flow chart illustrating one example of a method for operating a rectifier device to implement voltage clamping while maintaining thermal stability of the rectifier device.

FIG. 17 illustrates an exemplary three-phase full-wave rectifier circuit composed of six rectifier devices connected to a three-phase alternator.

### DETAILED DESCRIPTION

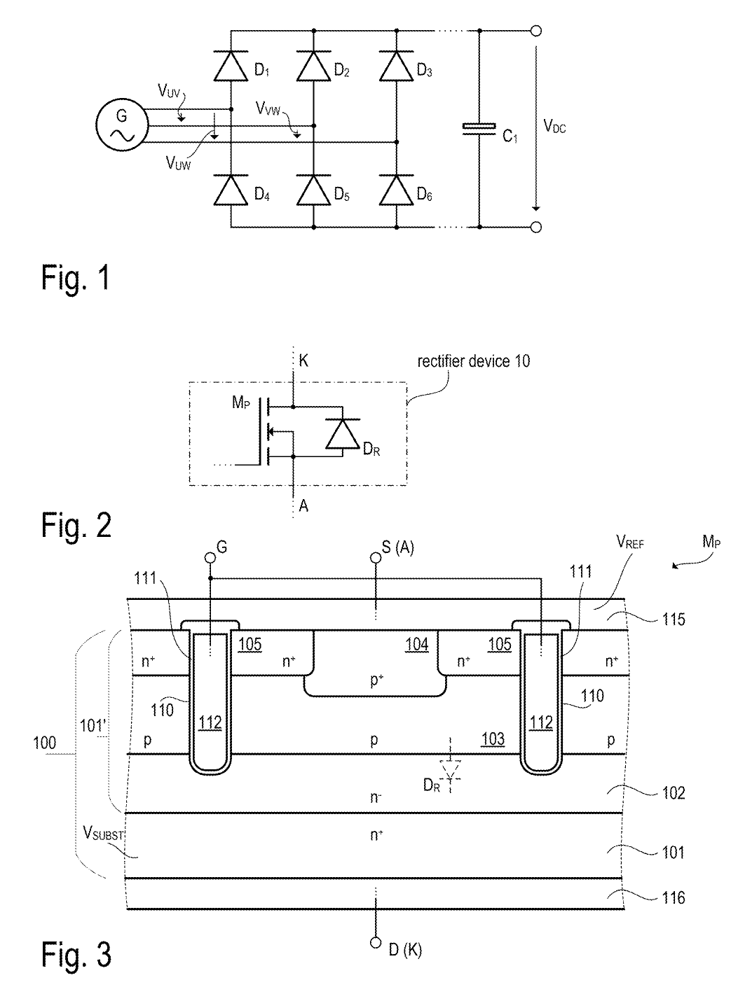

As mentioned above, several types of rectifiers exists. FIG. 1 illustrates, as an illustrative example, a three-phase full-wave rectifier, which is built using six diodes D₁, D₂, D₃, D₄, D₅, D₆ connected in a bridge configuration (a so-called three-phase rectifier bridge). FIG. 1 also illustrates a three-phase AC voltage source G, which may represent, for example, the electric grid, the secondary sides of a three-phase transformer, an AC generator such as a three-phase alternator used in an automobile, or any other common AC voltage source. The voltage source G provides three-phases connected to the rectifier bridge. The AC voltages between the phases are denotes as V_{UV}, V_{UW}, and V_{VW}, respectively. A capacitor C₁ may be connected to the output of the rectifier bridge to reduce the ripple of the DC output voltage V_{DC}. As mentioned, an automotive battery may be coupled to the rectifier bridge so that the battery can be charged by the generator G. Silicon diodes usually have a forward voltage of approximately 0.6 to 0.7 volts, and therefore may cause significant power dissipation. To reduce the power dissipation, a silicon diode may be replaced by a rectifier device including a controllable semiconductor switch. In the example illustrated in FIG. 2, the rectifier device 10 includes a power MOS transistor M_{P} (MOSFET), which has an intrinsic diode D_{R} (body diode) coupled in parallel to the load current path (drain-source current path) of the power MOS transistor M_{P}. Anode and cathode of the rectifier device 10 correspond to anode and cathode of the intrinsic diode and are labelled A and K, respectively. Although a MOSFET is used in the examples described herein an IGBT with an integrated reverse diode may be used instead. Generally, the rectifier device 10 may be used as a replacement for a normal silicon diode.

Unlike in known active rectifier circuits (also referred to as “synchronous rectifiers”), the power MOS transistor M_{P} is operated in a reverse conducting mode. In essence, a standard rectifier diode (as used for example in the rectifier bridge of FIG. 1) is replaced by the body diode (see FIG. 2, diode D_{R}) of a power MOS transistor, which can be bypassed by the MOS channel of the power MOS transistor, when the power MOS transistor is switched on. That is, the power MOS transistor is switched on (which makes the MOS channel conductive), when the body diode is forward biased, thus bypassing the current path through the body diode. When the diode D_{R} is reverse biased the MOSFET M_{P} is always off. In the example depicted in FIG. 2, the rectifier device 10 has only two terminals, a first terminal A (connected to the anode of the body diode D_{R}) and a second terminal K (connected to the cathode of the body diode D_{R}). As will be explained later, the control circuit used for switching the MOSFET M_{P} on and off may be integrated in the same semiconductor die as the MOSFET M_{P}, and the internal supply of the integrated control circuit may be internally generated from the AC voltage applied at the two terminals A and K.

FIG. 3 illustrates one exemplary implementation of the power MOS transistor M_{P} of FIG. 2 in a silicon substrate. In the present example, the MOSFET is implemented using a vertical transistor structure composed of a plurality of transistors cells. The term “vertical” is commonly used in the context of power transistors and refers to the direction of the load current path (MOS channel), which extends vertically with respect to a horizontal plane defined by the bottom plane of the semiconductor substrate. The term “vertical” can thus be used to discriminate vertical transistors from planar transistors, in which the load current path (MOS channel) extends parallel to the horizontal plane. In the present example, the vertical MOS transistor is implemented as a so-called trench transistor, which has its gate electrodes arranged in trenches formed in the silicon body. However, other types of vertical power transistors or other types of transistors may be used.

In the example of FIG. 3, the semiconductor body 100 is essentially formed by a semiconductor substrate 101 (wafer), on which a (e.g. monocrystalline) semiconductor layer 101′ is deposited using epitaxial growth. The semiconductor substrate 101 and the semiconductor layer 101′ may be doped with dopants of a first doping type, e.g. n-type dopants, wherein the concentration of dopants may be much lower in the semiconductor layer 101′ (therefore labelled n⁻) as compared to the highly doped substrate 101 (labelled n⁺). Trenches 110 are formed in the semiconductor layer by an anisotropic etching process. The trenches 110 extend—from the top surface of the semiconductor body 100—vertically into the semiconductor body 100 and are filled with conductive material (e.g. highly doped polycrystalline silicon) to form gate electrodes 112 within the trenches 110. The gate electrodes 112 are isolated from the surrounding semiconductor body 100 by an oxide layer 111, which is disposed on the inner surfaces of the trenches 110 before filling them with the mentioned conductive material.

An upper portion of the semiconductor layer 101′ is doped with dopants of a second doping type, e.g. p-type dopants, e.g. using a first doping process (e.g. diffusion process of dopants or ion implantation). The resulting p-doped region is usually referred to as body region 103, whereas the remaining n-doped portion of the semiconductor layer 101′ (directly adjoining the substrate 101) forms the so-called drift region 102 of the MOS transistor. As the trenches 110 extend down to the drift region 102, the body region 102 is segmented into a plurality in body regions associated with a respective plurality of transistor cells.

A second doping process (e.g. diffusion process of dopants or ion implantation) is used to form source regions 105. Therefore, the MOS transistor M_{P} is also referred to as DMOS (double-diffused metal-oxide-semiconductor) transistor. The source regions are doped with dopants of the same type as the substrate 101 (e.g. n-type dopants). The concentration of dopants may be comparably high (therefore labelled n⁺), but is not necessarily equal to the concentration of dopants in the substrate 101. The source regions 105 extend vertically into the semiconductor body starting from the top surface of the semiconductor body and adjoining the trenches 112. Body contact regions 104, which are doped with dopants of the same type as the body regions 103, may be formed between neighboring trenches 110 in order to allow to electrically contact the body regions 103 at the top surface of the semiconductor body 100. The source regions 105 and the body contract regions 104 are electrically contacted at the top surface of the semiconductor body 100 by the conductive layer 115 (e.g. metal layer) that forms the source electrode S of the power MOS transistor (DMOS transistor). Thereby the individual transistors cells are electrically connected in parallel. The gate electrodes 112 in the trenches 110 have to be isolated from the conductive layer 115 and are also connected to each other, e.g. at the end of the trenches 110 (not visible in FIG. 3). The drain electrode D is formed by another conductive layer 116 at the bottom surface of the semiconductor body 100.

The body diode D_{R} (see also FIG. 3) of the MOSFET is also shown in the cross-sectional view of FIG. 3. It is formed by the p-n junctions at the transition between the body regions 103 (in each transistor cell) and the drift region 102. The source electrode S (which is electrically connected to the source and body contact regions) is therefore also the anode of the diode D_{R}, and the drain electrode D is also the cathode of the diode D_{R}. A transistor designed according to the example of FIG. 3 or similar transistor designs are as such known (sometimes referred to as DMOS transistor) and thus not further explained in more detail.

What should be mentioned at this point is that the MOS transistor M_{P} is not the only component integrated in the substrate. All other circuitry needed for controlling the switching operation of the MOS transistor M_{P} may also be integrated in the same semiconductor body 100. The embodiments described herein may be designed as two-terminal rectifier devices (terminals A and K), which have only two external pins and behave essentially like diodes. Unlike a normal diode, the rectifier devices described herein may be designed to have a very low forward voltage as the low-resistive MOS channel bypasses the current path through the body diode D_{R} while the body diode is forward biased. In the following, the potential at the first terminal A (anode, corresponds to the source electrode of the power MOS transistor M_{P}) is denoted as reference voltage V_{REF}, whereas the voltage at the second terminal K (cathode, corresponds to the drain electrode of the power MOS transistor M_{P}) is denoted as substrate voltage V_{SUBST} (voltage present in the substrate 101, see FIG. 3).

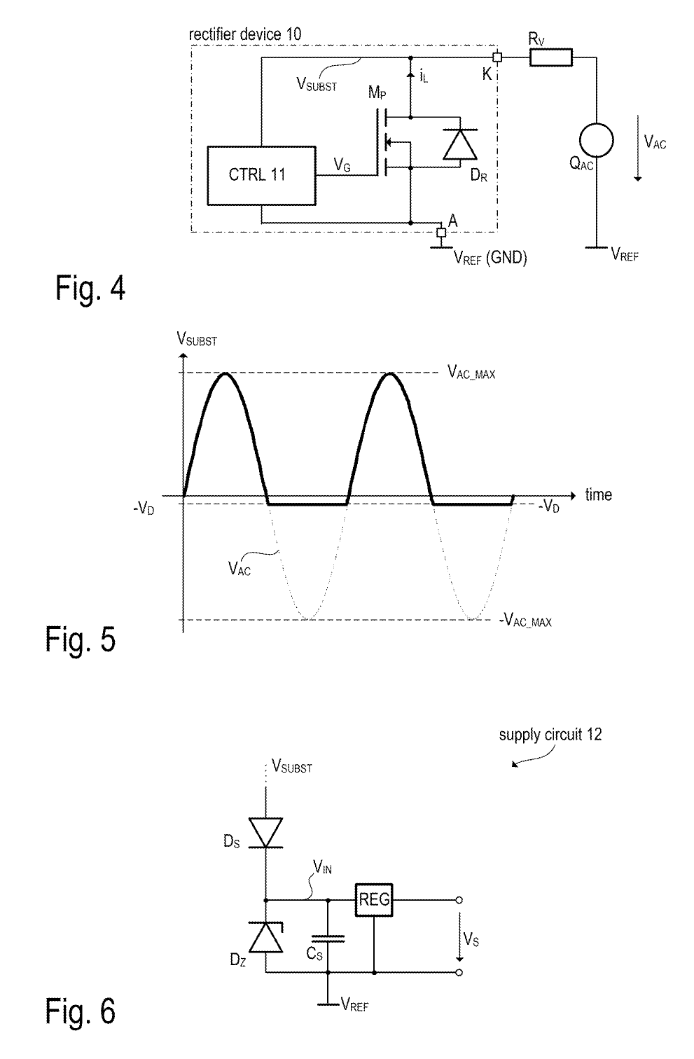

FIG. 4 illustrates the rectifier device 10 of FIG. 2 in more detail. Accordingly, the rectifier device includes the MOSFET (DMOS transistor) M_{P}, which includes the intrinsic reverse diode D_{R} (see FIG. 2) as well as a control circuit 11 connected to a gate terminal of the MOS transistor M_{P}. As explained above, the MOS transistor M_{P} and its intrinsic body diode D_{R}—and also the control circuit 11—are connected between the first and the second terminals A and K, respectively. The electric potential V_{REF} at the first terminal (anode) can be defined as zero volts (0 V) and can thus be regarded as reference or ground potential (ground GND) for all circuitry integrated in the semiconductor body 100. With respect to the reference potential V_{REF}, the substrate voltage V_{SUBST} may oscillate from negative values of approximately −0.7 volts minimum (i.e. the negative forward voltage of the body diode D_{R}) to a positive peak value V_{AC}_{_}_{MAX} of an alternating input voltage applied between the two terminals A and K. In the example of FIG. 4, the rectifier device 10 is supplied by an AC source Q_{AC} via a resistor R_{V}. However, supplying the rectifier device 10 as illustrated in FIG. 4 has to be regarded merely as a hypothetical example, which is used to explain the function of the rectifier device 10.

FIG. 5 is a timing diagram illustrating the waveform of the substrate voltage V_{SUBST} with respect to the reference potential V_{REF} for the hypothetic case, in which the MOSFET M_{P} included in the rectifier device 10 is never switched on and, therefore, the load current i_{L} can only pass the rectifier device 10 via the body diode D_{R}. In this example it is further assumed that an alternating input voltage V_{AC} is applied to a series circuit of the rectifier device 10 and a load (see FIG. 4, resistor R_{V}). Without loss of generality, the reference potential V_{REF} may be defined as 0 V. While the body diode D_{R} is reverse biased (V_{SUBST}>0 V), the substrate voltage V_{SUBST} follows the alternating input voltage V_{AC} and the load current is approximately zero (diode D_{R} is blocking). While the body diode D_{R} is forward biased (V_{SUBST}<0V), the substrate voltage V_{SUBST} follows the alternating input voltage V_{AC} as long as the alternating input voltage V_{AC} is higher than the negative forward voltage −V_{D} of the body diode D_{R} (e.g. V_{AC}>−0.6V). However, when the instantaneous level of the alternating input voltage V_{AC} becomes lower (i.e. more negative) than the negative forward voltage −V_{D} of the body diode D_{R} (e.g., V_{AC}<−0.6V), the substrate voltage V_{SUBST} will be approximately limited to the negative forward voltage −V_{D} of the body diode D_{R} (e.g., V_{SUBST}≈−0.6V), the diode D_{R} is conductive, and the difference between the (negative) substrate voltage and the alternating input voltage V_{AC} is the voltage drop across the load (e.g., resistor R_{V} in the example of FIG. 4). The load current i_{L} actually passing through the rectifier device 10 (while V_{AC}<−V_{D}) depends on the load.

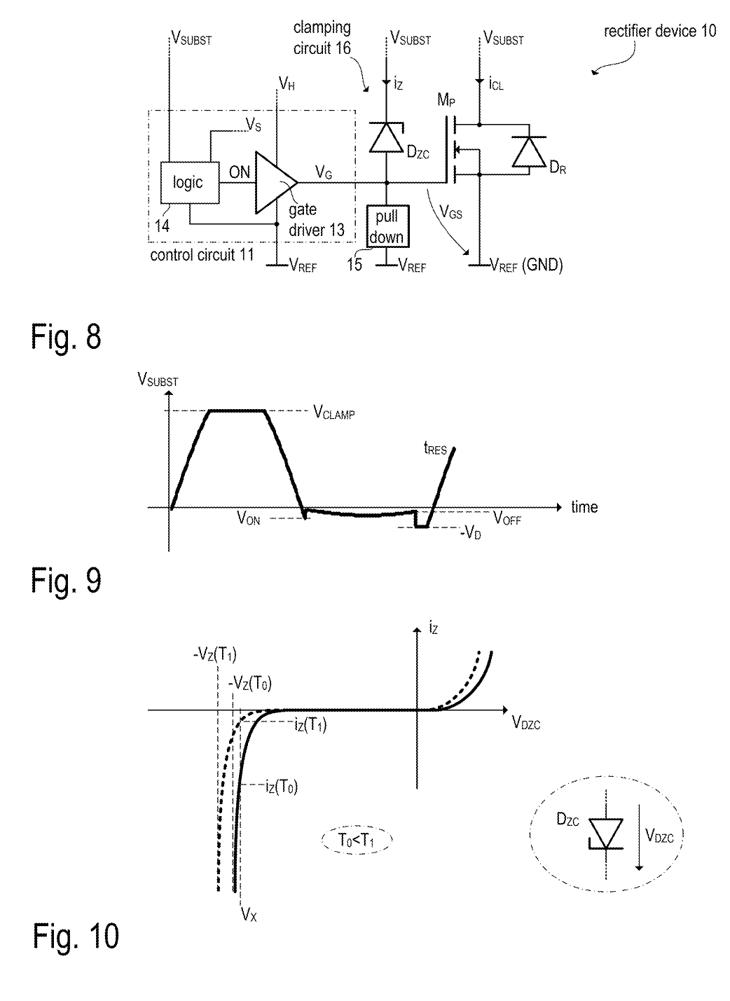

As mentioned above, a voltage drop across the rectifier device 10 of approximately 600 to 700 mV (at room temperature) may cause a significant power dissipation. To reduce the substrate voltage V_{SUBST} while the body diode D_{R} is forward biased, the MOS transistor M_{P} can be switched on to make the MOS channel of the MOS transistor M_{P} conductive. In this case, the body diode D_{R} is bypassed via the low-ohmic current path provided by the MOS channel. However, in the time period, in which the body diode D_{R} is reverse biased (i.e. blocking), the MOS transistor should remain switched off. The logic circuit controlling the switching operation of the MOS transistor M_{P} is included in the control circuit 11 (see FIGS. 4 and 8).

As shown in FIG. 4, the control circuit 11 is coupled between the two terminals A and K, at which the alternating input voltage is applied (see FIG. 5). However, some circuit components in the control circuit 11 need a DC supply voltage in order to operate properly. Therefore, the control circuit 11 may include at least one supply circuit, which provides an internal supply voltage V_{S} for supplying various other circuit components of the control circuit 11. Before explaining exemplary implementations of the control circuit 11 and its function in more detail, an exemplary implementation of the internal supply circuit is explained with reference to FIG. 6.

The exemplary supply circuit 12 illustrated in FIG. 6 is coupled between the first terminal A (reference potential V_{REF}) and the second terminal K (substrate voltage V_{SUBST}), which are connected to the source and drain of the power MOS transistor M_{P}, respectively. In this example, a series circuit composed of a diode D_{S} and a Zener diode D_{Z} is electrically connected between the substrate (being at substrate voltage V_{SUBST}) and the source electrode of the MOS transistor M_{P} (being at reference potential V_{REF}). A buffer capacitor C_{S} is connected parallel to the Zener diode D_{Z} as shown in FIG. 6. The capacitor C_{S} is charged via the diode D_{S} when the level of the substrate voltage V_{SUBST} is higher than the sum of the voltage V_{IN} across the capacitor C_{S} and the forward voltage of the diode D_{S}. The Zener diode D_{Z} limits the capacitor voltage V_{IN} across the capacitor C_{S} to a maximum value, which is determined by the Zener voltage of the Zener diode D_{Z}. Furthermore, the diode D_{S} prevents the discharging of the capacitor C_{S} via the substrate when the substrate voltage V_{SUBST} falls to values lower than the capacitor voltage V_{IN}. The capacitor voltage V_{IN} may be supplied as input voltage to a voltage regulator device REG, and the input voltage V_{IN} is buffered by the capacitor C_{S} while the substrate voltage V_{SUBST} is low. The regulated output voltage of the voltage regulator REG is denoted as V_{S}. The regulated output voltage V_{S} may be regarded as internal supply voltage that is used to supply any circuitry (such as logic circuits) integrated in the rectifier device 10.

It is noted, that the circuit of FIG. 6 has to be regarded as an illustrative example and may also be implemented in various alternative ways. For example, the Zener diode D_{Z} may be replaced by a any voltage limiting circuit configured to limit the capacitor voltage to a desired maximum. Further, diode D_{S} may be replaced by a transistor which may be able to limit the current passing through it. Dependent on the application the Zener diode D_{Z} may be omitted. The capacitor C_{S} may be replaced by any circuit (e.g. series or parallel circuit of several capacitors) providing a sufficient capacitance to be able to buffer the input voltage V_{IN} while the substrate voltage V_{SUBST} is too low to charge the capacitor C_{S}. In some implementations, the voltage regulator REG may be substituted by other circuitry that provides a similar function. If the capacitance of the capacitor C_{S} is high enough to ensure an acceptably low ripple, the regulator REG may be also omitted.

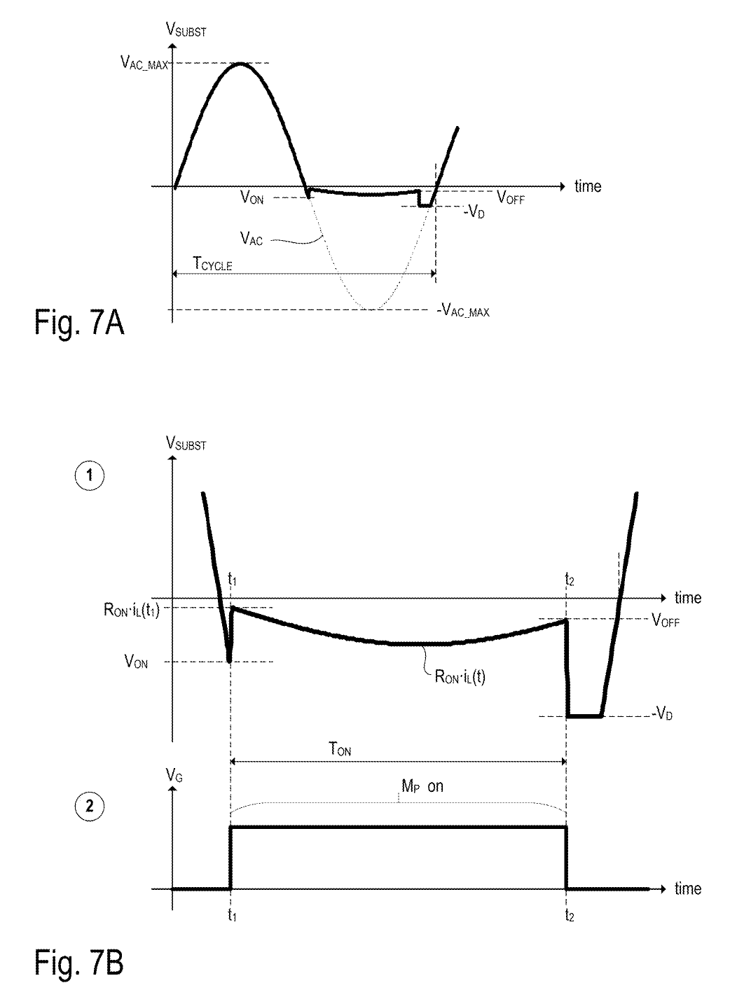

FIGS. 7A and 7B include timing diagrams illustrating the function of one exemplary embodiment of the rectifier device 10 implemented according to the basic example of FIG. 4. In particular, the function of the control logic used for switching on and switching off of the MOS transistor M_{P} is illustrated by the timing diagrams of FIGS. 7A and 7B. The diagram of FIG. 7A is essentially the same as the diagram of FIG. 5 except that, in the current example, power MOS transistor M_{P} is switched on, when the intrinsic body diode D_{R} is forward biased in order to bypass the body diode D_{R} via the activated MOS channel. The bypassing of the body diode D_{R} results in a voltage drop across the rectifier device 10, which is significantly lower than the forward voltage of a normal diode.

The first diagram of FIG. 7B shows a magnified segment of the waveform shown in FIG. 7A. FIG. 7A shows a full cycle of the substrate voltage V_{SUBST}, whereas the first diagram of FIG. 7B only shows approximately the second half of the cycle, during which the substrate voltage V_{SUBST} is negative. The second diagram of FIG. 7B illustrates a simplified waveform of the gate voltage applied to the MOS transistor M_{P} to switch it on and off. As can be seen in FIGS. 7A and 7B, the MOS transistor M_{P} is switched on, when the control circuit 11 detects that the substrate voltage V_{SUBST} is negative (i.e. the diode D_{R} is forward biased). This detection can be made based on various criteria. In the present example, negative threshold voltages V_{ON} and V_{OFF} are used to determine the time instants for switching the MOS transistor M_{P} on and off (i.e. begin and end of the on-time period T_{ON} of MOS transistor M_{P}). Accordingly, the MOS transistor M_{P} is switched on, when the substrates voltage V_{SUBST} reaches or falls below the first threshold V_{ON}, and the MOS transistor M_{P} is switched off, when the substrates voltage V_{SUBST} again reaches or exceeds the second threshold V_{OFF}.

In the present example, the condition V_{SUBST}=V_{ON} is fulfilled at time t₁ and the gate voltage V_{G} (see second diagram of FIG. 7B) is set to a high level to switch the MOS transistor M_{P} on. When the substrate voltage V_{SUBST} reaches or exceeds the second threshold V_{OFF} at the end of a cycle, the MOS transistor M_{P} is switched off again. In the present example, the condition V_{SUBST}=V_{OFF} is fulfilled at time t₂ and the gate voltage V_{G} (see bottom diagram of FIG. 7B) is set to a low level to switch the MOS transistor M_{P} off. When the MOS transistor M_{P} is switched off at time t₂, the substrate voltage V_{SUBST} may abruptly fall to −V_{D} before it again rises to positive values at the beginning of the next cycle. It is understood that the waveforms shown in FIGS. 7A and 7B are merely an illustrative example and are note in scale.

While the MOS transistor M_{P} is switched on (i.e. during the on-time period T_{ON}), the substrate voltage V_{SUBST} equals R_{ON}·i_{L}, wherein R_{ON} is the on-resistance of the activated MOS channel. In the present example, only two threshold values are used to switch the MOS transistor M_{P} on and off, respectively. However, two or more threshold values may be used for the switch-on and/or the switch-off. In this case the power MOSFET may be switched on or off (or both) gradually by subsequently switching on/off two or more groups of transistor cells of the power MOSFET. A more detailed example of a rectifier device, in which the power MOS transistor is “divided” into two transistors M_{P1} and M_{P2} is explained later with regard to FIG. 13.

Referring back to FIG. 7A, both, the first threshold V_{ON} and the second threshold V_{OFF} are negative (note that the reference voltage V_{REF} is defined as zero), but higher than the negative forward voltage −V_{D} of the body diode D_{R} of the MOS transistor M_{P}. Furthermore, the second threshold V_{OFF} is higher (less negative) than the first threshold V_{ON}. That is, the condition −V_{D}<V_{ON}<V_{OFF}<0 V is fulfilled in the present example, e.g. V_{ON}=−250 mV and V_{OFF}+=−50 mV, while −V_{D}≈−700 mV.

As can be seen in FIG. 7B, the MOS transistor M_{P} should only switch on once in each cycle (see FIG. 7A, period T_{CYCLE}) of the substrate voltage V_{SUBST}, when the condition V_{SUBST}=V_{ON} is met for the first time. When the condition is met again in the same cycle, a second switch-on of the MOS transistor M_{P} should be prevented (e.g. at time instant t₂, see first diagram of FIG. 7A). Similarly, the MOS transistor M_{P} should be switched off when the condition V_{SUBST}=V_{OFF} is met at the end of a cycle. If this condition is met earlier during a cycle (e.g. shortly after time t₁, if R_{ON}·i_{L}(t₁)>V_{OFF}), an early switch-off of the MOS transistor should be prevented. In order to avoid an undesired early switch-off of the MOS transistor, the control circuit may include a timer that prevents a switch-off for a specific time span (e.g. during the first half of the on-time T_{ON}). It is noted that control logic that exhibits the behaviors illustrated in FIGS. 7A and 7B may be implemented in numerous different ways. The actual implementation may depend on the application as well as on the semiconductor technology used for manufacturing the rectifier device 10. It is understood that a skilled person is able to implement the functionality discussed above with reference to FIGS. 7A and 7B.

FIG. 8 is a block diagram illustrating one exemplary implementation of a control logic for the control circuit 11 (see FIG. 4) which is designed to switch the MOS transistor M_{P} on and off as illustrated in the timing diagrams of FIGS. 7A and 7B. Various circuit components used in the circuit of FIG. 8 may be supplied by a supply circuit 12 as shown, for example, in FIGS. 6A and 6B (internal supply voltage V_{S}). In the present example, the control logic 14 includes a comparator that receives the substrate voltage V_{SUBST} at a first input (e.g. inverting input) and a threshold voltage V_{R} at a second input (e.g. non-inverting input). The substrate voltage V_{SUBST} and the threshold voltage V_{R} are compared by the comparator, which generates a binary comparator output signal (high/low logic signal). In the present example, the control logic generates a high level at its output ON when the substrate voltage V_{SUBST} is below the threshold voltage V_{R}.

In applications, in which a rectifier bridge are connected with an alternator, a voltage limitation (voltage clamp) may be provided in order to protect the rectifier devices in the rectifier bridge from an over-voltage. An overvoltage may particularly occur when the electric load is disconnected from the alternator during operation of the alternator. In an automobile this situation may occur, for example, when the battery is disconnected from the alternator, while the alternator is running. The energy generated by the alternator should then be dissipated in a controlled way.

FIG. 8 illustrates one exemplary implementation of the rectifier device 10 with control logic 11 and a clamping circuit 16, which is basically composed of a Zener diode D_{ZC}. It is understood that more complex clamping circuits may be used. In the present example, the MOS transistor M_{P} is the same as in the previous example of FIG. 4. The control circuit 11 includes a logic circuit 14, which implements the function explained above with reference to FIGS. 7A and 7B, and a gate driver 13 that generates a gate signal V_{G} based on the logic signal ON provided by the logic circuit 14. The internal supply voltage V_{S} may be provided by a supply circuit as shown, for example, in FIG. 6. The supply voltage V_{H} for the gate driver 13 may be buffered, for example, by a capacitor (not shown). The clamping circuit 16 may be coupled to the gate electrode of the power MOS transistor M_{P}. In the present example, the Zener diode D_{ZC} is connected between the gate electrode of the power MOS transistor M_{P} and substrate (e.g. the terminal K of the rectifier device).

The effect of the clamping circuit 16 is illustrated by the timing diagram of FIG. 9. The diagram of FIG. 9 is substantially the same as the diagrams of FIGS. 7A and 7B except that the substrate voltage V_{SUBST} is clamped to a maximum voltage V_{CLAMP} (clamping voltage). As can be seen from FIG. 9 a voltage clamping can only occur while the diode is reverse biased, i.e. during the positive half-wave of the substrate voltage V_{SUBST}. During normal operation, the power MOS transistor M_{P} is off in this situation and the gate driver 13 keeps the gate-source voltage V_{GS} at a sufficiently low level. The clamping voltage V_{CLAMP} is approximately the sum of the Zener voltage V_{Z} of the Zener diode D_{ZC} and the threshold voltage V_{GSX} of the power MOS transistor M_{P} (V_{CLAMP}≈V_{Z}+V_{GSX}). When the substrate voltage V_{SUBST} reaches the clamping voltage V_{CLAMP}, the potential at the gate electrode of MOS transistor M_{P} is pulled up as the voltage drop across the Zener diode D_{ZC} is limited to the Zener voltage V_{Z}. Accordingly, the level of the gate-source voltage V_{OS} increases until it reaches the threshold voltage V_{GSX}. As a consequence, the power MOS transistor M_{P} becomes partly conductive; a load current i_{CL} passes through the power MOS transistor M_{P} thus preventing a further increase of the substrate voltage. As can be seen from FIG. 9, the peak power dissipated in the power MOS transistor M_{P} equals i_{CL}·V_{CLAMP}, which produces a significant amount of heat in the active regions of the power MOS transistor M_{P}.

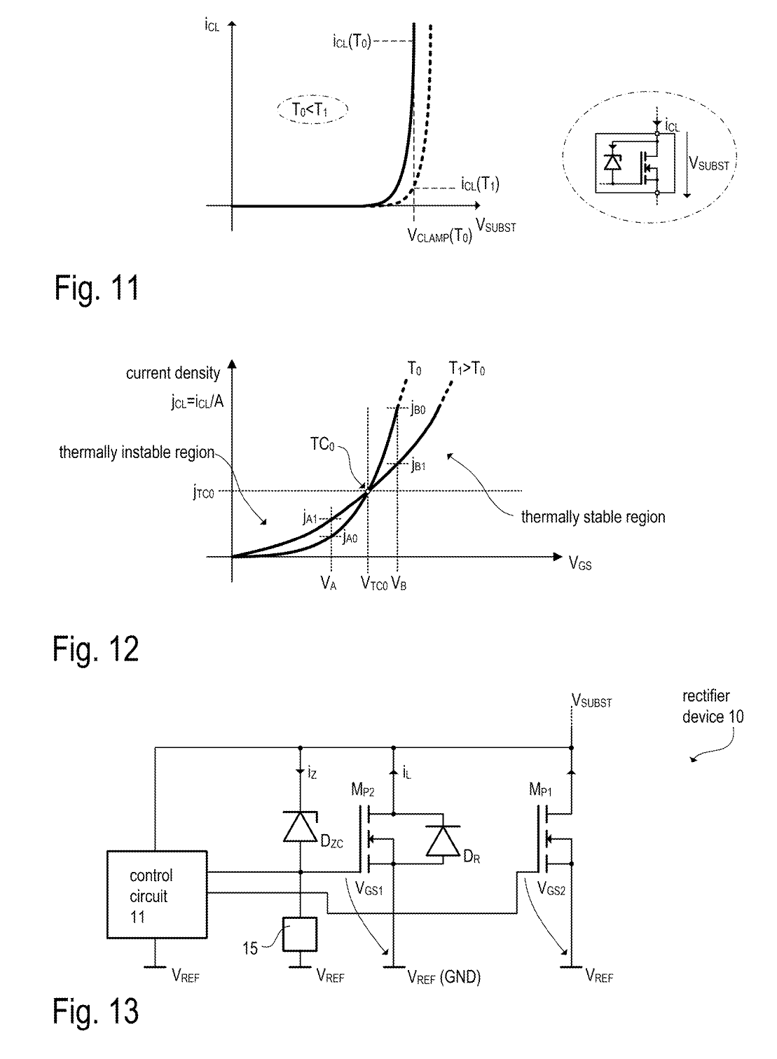

FIGS. 10, 11 and 12 illustrate characteristic curves of the Zener diode D_{ZC} and, respectively, the power MOS transistor M_{P} as well as how these characteristic curves change as temperature increases. As mentioned, a significant amount of heat may be dissipated in the rectifier device 10 when voltage clamping is active. Naturally, this heat dissipation leads to an increase of temperature in the semiconductor body. Before discussing the diagrams of FIGS. 10 and 11 it should be noted that the Zener diode D_{ZC} and the MOS transistor M_{P} may be integrated in the same semiconductor chip and thus be thermally coupled. That is, if the MOS transistor M_{P} becomes hot, the diode D_{Z} will also become hot.

FIG. 10 illustrates the characteristic curve of the Zener diode D_{ZC}. It behaves as any Zener diode: it has an exponential voltage-current characteristic, when the diode is forward biased (V_{DZC} is positive), and exhibits a breakdown at the Zener voltage V_{Z}, when the diode is reverse biased (V_{DZC}=−V_{Z}). Usually, the breakdown is a combination of a Zener breakdown and an avalanche breakdown, wherein avalanche breakdown is the predomination effect for larger Zener voltages. The avalanche effect exhibits a positive temperature coefficient so that V_{Z}(T₁) for a temperature T₁ is higher than a V_{Z}(T₀) for a temperature T₀, is T₁>T₀. Accordingly, for a given voltage V_{X} the Zener current i_{Z}(T₁) is significantly smaller for higher temperatures than the current i_{Z}(T₀) for lower temperatures. Less Zener current it entails less charge on the gate electrode of the MOS transistor M_{P}, and thus the MOS transistor M_{P} becomes conductive at a higher substrate voltage V_{SUBST} when the temperature is high than it would be the case if the temperature was low.

FIG. 11 is a diagram illustrating the temperature dependency of the characteristic curve of the rectifier device 10 including a power MOS transistor M_{P} and a clamping circuit with a Zener diode D_{Z} as illustrated, for example in FIG. 8. The diagram illustrates the current i_{CL} passing through the rectifier device during clamping. That is, the current i_{CL} is substantially zero as long as V_{SUBST}<V_{CLAMP}, and rises sharply for when the substrates voltage V_{SUBST} reaches V_{CLAMP}. The shape of the characteristic curve is essentially determined by the left part of the characteristic curve (illustrating Zener and avalanche breakdown) of a Zener diode as explained before with regard to FIG. 10. The temperature characteristic of the voltage V_{CLAMP} depends, inter alia, on the temperature characteristic of the Zener voltage V_{Z} (see FIG. 10). That is, the voltage V_{CLAMP} has a positive temperature coefficient, and thus the load current i_{CL} will fall—for a given level of the substrate voltage V_{SUBST}—from i_{CL}(T₀) to i_{CL} (T₁) when temperature rises from T₀ to T₁. The positive temperature coefficient leads to a thermally stable behavior of the rectifier circuit; if the device gets hot the load current i_{CL} will fall thus reducing the power dissipation. When more (e.g. six) rectifier devices are operated in one rectifier bridge the hotter devices will sink less current which leads to a thermal stable behavior of the whole rectifier bridge. However, the individual rectifier devices should also exhibit a thermally stable behavior.

FIG. 12 is a diagram illustrating the characteristic curve of the power MOS transistor M_{P} itself (load current density j_{CL} over gate-source voltage V_{GS}), whereas the characteristic curve of FIG. 11 is basically determined by the characteristic curve of the clamping circuit (Zener diode). The load current density j_{CL} equals i_{CL}/A wherein A represents the area available for the current flow through the MOS transistor M_{P}. It can be seen from FIG. 12 how the characteristic curve changes when temperature increases. Accordingly, as temperature rises from T₀ to T₁ the characteristic curve is shifted towards higher current densities in the segment j_{CL}<j_{TC0} and towards lower current densities in the segment j_{CL}>j_{TC0}. At the current density j_{TC0} the characteristic curve does not change over temperature. That is, the point TC₀ (i_{TC0}/V_{TC0}) has a temperature coefficient of zero. One can see from FIG. 12 that the MOS transistor M_{P} is thermally stable only when operated at higher current densities, i.e. in the segment i_{CL}>j_{TC0} of the characteristic curve. Accordingly, for a gate-source voltage V_{B} the current density jet will fall from j_{B0} to j_{B1} when the temperature increases from T₀ to T₁. In the instable segment i_{CL}<j_{TC0} of the characteristic curve the current density j_{CL} will rise from j_{A0} to j_{A1} for a given gate-source voltage VA when the temperature increases from T₀ to T₁.

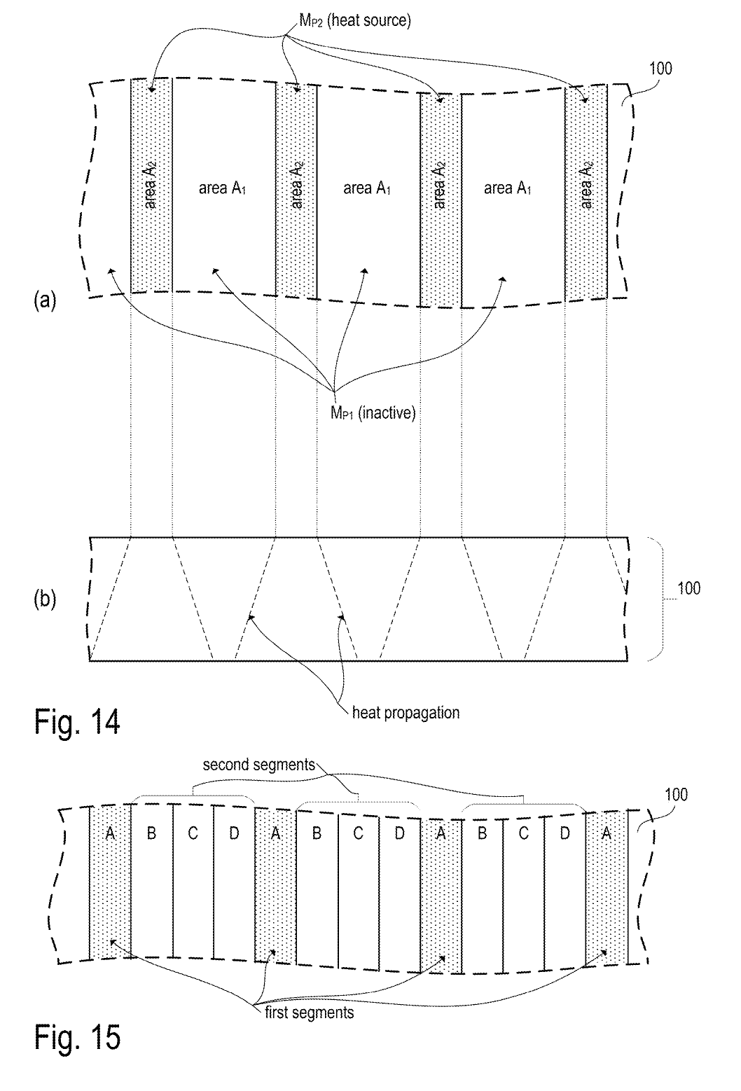

In order to operate the power MOS transistor in a thermally stable region of the characteristic curves the current density j_{CL}=i_{CL}/A should be higher than the current density j_{TC0} in the point TC₀. To increase the current density, the area A available for the load current i_{CL} during clamping can be reduced by only using a portion of the transistor cells of the power MOS transistor M_{P} during clamping. This concept is illustrated in FIGS. 13 and 14. The example of FIG. 13 is basically the same as the previous example of FIG. 8 except that the power MOS transistor M_{P} is “split” into two transistors M_{P1} and M_{P2} whose load current paths are connected in parallel. Nevertheless, the MOS transistors M_{P1} and M_{P2} can be switched on and off separately. The two MOS transistors M_{P1} and M_{P2} may be integrated in the same array of transistor cells, wherein a first (e.g. greater) portion of transistor cells is assigned to transistor M_{P1} whereas a second (e.g. smaller) portion of transistor cells is assigned to transistor M_{P2}. As can be seen from FIG. 13. The clamping circuit 16 (e.g. the Zener diode D_{ZC}) is only coupled to the gate terminal of the second MOS transistor M_{P2}, wherein the first MOS transistor M_{P2} remains always off during clamping (but, nevertheless, may still be activated when the body diode D_{R} is forward biased). As only the area A₂ of the smaller MOS transistor M_{P2} is used during voltage clamping, the current density j_{CL} is significantly higher than it would be the case if both transistors M_{P1} and M_{P2} were used for voltage clamping. The current densities through the MOS channels of the transistors M_{P1} and M_{P2} may be tuned and optimized by assigning more or less transistor cells to the transistors, wherein less transistor cells means a smaller area and a higher current density.

FIG. 14 illustrates the distribution of the transistor cells throughout the semiconductor chip, wherein diagram (a) of FIG. 14 is a top view and diagram (b) is a side view of the semiconductor chip. According to the depicted example, transistor cells assigned to the smaller MOS transistor M_{P2} and transistor cells assigned to the larger MOS transistor M_{P1} are arranged in an alternating manner so that the active area A₂ of MOS transistor M_{P2} is (e.g. regularly) intermitted by transistor cells assigned to MOS transistor M_{P1} (area A₁), which are passive during clamping, and may also intermitted by other circuitry. During voltage clamping, heat is only generated in the active areas of the transistor cells assigned to MOS transistor M_{P2} (area A₂) due to the power dissipation i_{CL}·V_{CLAMP}. By using only one portion of the transistor cells the current density is increased by a factor of A₂/(A₁+A₂) as compared to the case, in which all transistor cells would be active. In one example only 30% or less of the transistor cells are active during voltage clamping. In another example only 15% or less of the transistor cells are active during voltage clamping. As already explained with reference to FIG. 13, the high current density leads to a thermally stable working point during clamping. Thus, the formation of hot spots in the semiconductor body 100 is avoided.

As can be seen in diagram (b) of FIG. 14, the inactive transistor cells, in which no heat is dissipated during voltage clamping, allow for an improved heat transport out of the active areas of the MOS transistor M_{P2} and into the inactive transistor cells of MOS transistor M_{P1}. The heat can easily spread throughout the whole semiconductor chip and the fully area A₁+A₂ is available for sinking heat (e.g. via a printed circuit board). Local hot spots in the semiconductor chip are avoided because the rectifier device is operated in a thermally stable state. As mentioned above, the available area (area of transistor M_{P2}) for the load current i_{CL} during clamping is only a portion of the total area of transistors M_{P1} and M_{P2}. As a consequence, the current density is so high that the transistor M_{P2} is operated in a thermally stable operating point as explained above with reference to FIG. 12.

The example of FIG. 15 illustrates the assignment of individual transistor cells to different segments of the chip area. The transistor cells A, B, C, and D are grouped in two groups, wherein the first group includes only transistor cells B, C, and D that are assigned to the first transistor M_{P1} (i.e. connected in parallel to form one transistor), and the second group includes only transistor cells A that are assigned to the second transistor M_{P2}. As can be seen from FIG. 15, the transistor cells B, C, D of the first group are arranged in first segments of the chip area, whereas the transistor cells A of the second group are arranged in second segments of the chip area. Assuming all transistor cells A, B, C, and D having the same area available for the load current, the total area of the second segments is one third of the area of the second segments.

To further decrease the risk of the formation of hot spots, the assignment of the transistor cells may be changed regularly or from time to time. In the example depicted in FIG. 15 the transistor M_{P2} is composed of transistor cells A, whereas the transistor M_{P1} is composed of transistor cells B, C, and D. The assignment of transistor cells may be changed (rotated) so that the transistor M_{P2} is composed of transistor cells B, whereas the transistor M_{P1} is composed of transistor cells C, D, and A. Subsequently, the assignment of transistor cells may be further rotated so that the transistor M_{P2} is composed of transistor cells C, whereas the transistor M_{P1} is composed of transistor cells D, A, B. Finally, the assignment of transistor cells may be further rotated so that the transistor M_{P2} is composed of transistor cells D, whereas the transistor M_{P1} is composed of transistor cells A, B, C, and so on. A rotation of the transistor cell assignment may be triggered, for example, each time the clamping circuit activates the transistor M_{P2}.

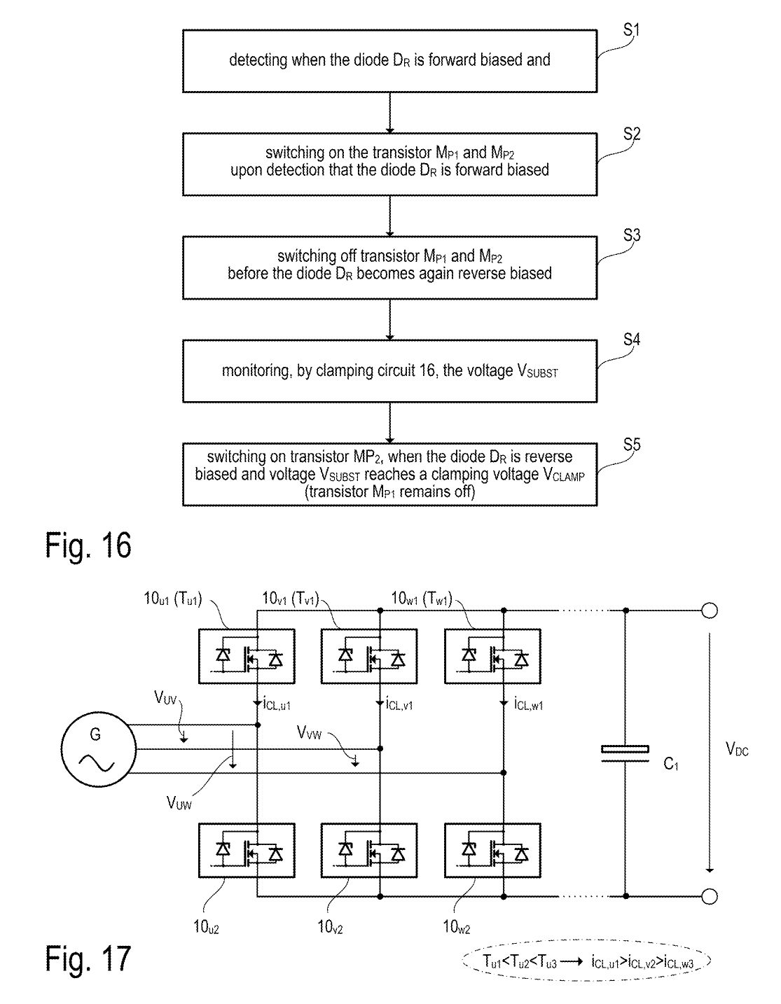

FIG. 16 is a flow chart illustrating one exemplary method of operating a rectifier device to implement the clamping function as explained above with reference to FIGS. 1 to 15. Accordingly, the rectifier device has a first transistor M_{P1} and a second transistor M_{P1} and a diode D_{R} coupled in parallel between an anode terminal A and a cathode terminal K (see also FIG. 4). In the present example, the method includes the detection (FIG. 16, step S1) when the diode D_{R} is forward biased and switching on the first and the second transistor M_{P1} and M_{P2} upon detection that the diode D_{R} is forward biased (FIG. 16, step S2). The method further includes switching off the first and the second transistor M_{P1} and M_{P2} before the diode D_{R} becomes again reverse biased (FIG. 16, step S3). In order to provide a clamping of the voltage V_{SUBST} applied between the anode and the cathode terminal A and K, the clamping circuit 16 monitors the voltage V_{SUBST} (FIG. 16, step S4). The second transistor M_{P2} is switched on, when the diode D_{R} is reverse biased and the voltage V_{SUBST} reaches clamping voltage V_{CLAMP}. Thereby, the first transistor M_{P1} remains off for the reasons described with reference to FIGS. 13-15.

FIG. 17 illustrates an exemplary three-phase full-wave rectifier circuit composed of six rectifier devices 10ᵤ₁, 10ᵤ₂, 10ᵥ₁, 10ᵥ₂, 10_{w1}, and 10_{w2} connected to a three-phase alternator G similar to the conventional rectifier shown in FIG. 1. As can be seen in FIG. 17, the rectifier devices 10ᵤ₁, 10ᵤ₂, 10ᵥ₁, 10ᵥ₂, 10_{w1}, and 10_{w2} are two-terminal devices (two-poles) an can be used as replacements for standard silicon diodes without further modification of the rectifier bridge circuit. In the present example—when the voltage V_{UV} between the phases U and V is positive and reaches the clamping voltage V_{CLAMP} (e.g. because the battery was disconnected from the alternator), the rectifier devices 10ᵤ₁ and 10ᵥ₂ are forward biased and the voltage drop across these rectifier devices 10ᵤ₁ and 10ᵥ₂ is only a view ten millivolts, whereas the rectifier devices 10ᵤ₂ and 10ᵥ₁ are reverse biased and the voltage limitation is activated due to the integrated clamping circuit (see, e.g., FIG. 8, clamping circuit 16). As a consequence, the load current i_{CL,v1} through the rectifier device 10ᵥ₁ causes the power dissipation V_{CLAMP}·i_{CL,v1} and an increase of the temperature Tᵥ₁.

As the alternator rotates, each of the rectifier devices 10ᵤ₁, 10ᵤ₂, 10ᵥ₁, 10ᵥ₂, 10_{w1}, and 10_{w2} subsequently runs into voltage limitation. However, due to the positive temperature coefficient (TC) of the clamping voltage (see FIGS. 10 and 11), and the negative TC of the load current i_{CL} during clamping operation of the rectifier device, the rectifier bridge as a whole exhibits a thermally stable behaviors; an increase in temperature in a specific rectifier device (e.g. temperature Tᵥ₁ in rectifier device 10ᵥ₁) will lead to a decrease of the load current (e.g., i_{CL,v1}) during clamping operation. Of course the current difference due to this decrease has to be taken over by another one of the rectifier devices. However, the thermally stable mechanism described above prevents a thermal runaway of a single rectifier device.

Several aspects of the embodiments described herein are summarized below. It is noted, however, that the following summary is not an exhaustive enumeration of features but rather an exemplary selection of features which may be important or advantageous in some applications. In accordance with one example (Example 1), a rectifier device includes a transistor that has a load current path and a diode connected parallel to the load current path. The diode and the load current path are connected between an anode terminal and a cathode terminal; an alternating input voltage is operably applied between the anode terminal and the cathode terminal. A control circuit is coupled to a gate terminal of the transistor and configured to switch the semiconductor switch on for an on-time period, during which the diode is forward biased. Moreover, a clamping circuit is coupled to a gate terminal of the transistor and configured to at least partly switch on the transistor, while the diode is reverse biased and the level of the alternating input voltage reaches a clamping voltage.

### Example 2

The rectifier device according to example 1, wherein the transistor is composed of a plurality of transistor cells, and wherein, in order to partly switch on the transistor, the clamping circuit is configured to only switch on a first group of transistor cells of the plurality of transistor cells, while a second group of transistor cells remains off.

### Example 3

The rectifier device according to example 2, wherein transistor cells of the first group are arranged in first segments of a semiconductor chip area and the transistor cells of the second group are arranged in second segments of the semiconductor chip area, the first and the second segments are arranged in the semiconductor chip in an alternating manner.

### Example 4

The rectifier device according to any of examples 1 to 3, wherein the clamping circuit includes at least one Zener diode coupled between the gate terminal and the cathode terminal of the transistor.

### Example 5

The rectifier device according to example 4, wherein the transistor is a MOS transistor, the cathode terminal is a drain terminal of the MOS transistor, and the anode terminal is a source terminal of the MOS transistor.

### Example 6

The rectifier device according to any of examples 1 to 5, wherein the control circuit is configured to detect the begin of the on-time period by detection that the diode has become conductive.

### Example 7

The rectifier device according to any of examples 1 to 6, wherein the control circuit is configured to detect the begin of the on-time period by detecting that the voltage drop across the diode has reached a defined first threshold voltage.

### Example 8

The rectifier device according to example 7, wherein the control circuit is configured to detect the end of the on-time period by detecting that the voltage drop across the load current path of the first semiconductor switch has reached a defined second threshold voltage.

In accordance with a further example (Example 9), the rectifier device includes a plurality of transistor cells integrated in a semiconductor body, wherein a first group of transistor cells are assigned to a first transistor and a second group of transistor cells are assigned to a second transistor. An anode and a cathode terminal or the rectifier device are connected by load current paths of the first transistor and the second transistor, and a diode is arranged in the semiconductor body between the anode and the cathode terminal. Further, a clamping circuit is arranged in the semiconductor body and coupled between a gate terminal of the first transistor and the cathode terminal. Transistor cells of the first group are arranged in first segments of the semiconductor body and the transistor cells of the second group are arranged in second segments of the semiconductor body.

### Example 10

The rectifier device according to example 9, wherein the first segments and the second segments are arranged in the semiconductor body in an alternating manner.

### Example 11

The rectifier device according to example 9 or 10, wherein the area of the first segments is smaller than the area of the second segments.

### Example 12

The rectifier device according to any of examples 9 to 11, wherein the clamping circuit includes a Zener diode, through which a Zener current passed from the first load terminal to the gate terminal of the first transistor when a voltage between the cathode terminal and the anode terminal reaches a clamping voltage.

### Example 13

The rectifier device according to any of examples 9 to 12, further including a control circuit integrated in the semiconductor body and configured to detect when the diode is forward biased and to switch on the first and the second transistor, subsequently or simultaneously, upon detection that the diode is forward biased.

### Example 14

The rectifier device according to any of examples 9 to 12, further including a control circuit integrated in the semiconductor body and configured to switch off the first and the second transistor, subsequently or simultaneously, before the diode becomes reverse biased.

### Example 15

The rectifier device according to any of examples 9 to 14, wherein the clamping circuit is configured to activate the first transistor when a voltage between the cathode and the anode terminal reaches a clamping voltage.

### Example 16

The rectifier device according to example 15, wherein the clamping circuit includes a Zener diode having a Zener voltage with a positive temperature coefficient, the clamping voltage depending on the Zener voltage.

### Example 17

The rectifier device according to any of examples 9 to 16, wherein the clamping circuit is configured to activate the first transistor when a voltage between the cathode and the anode terminal reaches a clamping voltage, and wherein the area of the first segments is so small that, during the first transistor is activated for clamping, the first transistor is operated in a thermally stable state.

Furthermore, a method for operating a rectifier device is described herein. In accordance with one example (Example 18) the rectifier device includes a first transistor and a second transistor and a diode coupled in parallel between an anode terminal and a cathode terminal, and the method includes: detecting when the diode is forward biased and switching on the first and the second transistor upon detection that the diode is forward biased, and switching off the first and the second transistor before the diode becomes again reverse biased. The method further includes monitoring, by a clamping circuit, a voltage between the cathode terminal and the anode terminal. The first transistor is switched on, when the diode is reverse biased and the voltage between the cathode terminal and the anode terminal reaches a clamping voltage, while the second transistor remains off.

Moreover, a rectifier bridge is described herein. In accordance with one example (Example 19), the rectifier bridge includes a plurality of rectifier devices, wherein each of the rectifier devices has an anode terminal and a cathode terminal. Further, the rectifier devices include a transistor having a load current path and a diode connected parallel to the load current path between the anode terminal and the cathode terminal, wherein an alternating input voltage is operably applied between the anode terminal and the cathode terminal. A control circuit is coupled to a gate terminal of the transistor and configured to switch the semiconductor switch on for an on-time period, during which the diode is forward biased, and a clamping circuit is coupled to gate terminal of the transistor and configured to at least partly switch on the transistor while the diode is reverse biased and the level of the alternating input voltage reaches a clamping voltage.

### Example 20

The rectifier bridge according to example 19, wherein, for each rectifier device, the transistor is composed of a plurality of transistor cells, and wherein, in order to partly switch on the transistor, the clamping circuit is configured to only switch on a first group of transistor cells of the plurality of transistor cells, while a second group of transistor cells remains off.

### Example 21

The rectifier bridge according to example 19 or 20, wherein, for each rectifier device, the clamping circuit is configured to provide a clamping voltage with a positive temperature coefficient.

Although the invention has been illustrated and described with respect to one or more implementations, alterations and/or modifications may be made to the illustrated examples without departing from the spirit and scope of the appended claims. As mentioned above, the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

We claim:

1. A rectifier device comprising:
a transistor having a load current path and a diode connected parallel to the load current path between an anode terminal and a cathode terminal; an alternating input voltage is operably applied between the anode terminal and the cathode terminal
a control circuit that is coupled to a gate terminal of the transistor and configured to switch the semiconductor switch on for an on-time period, during which the diode is forward biased,
a clamping circuit coupled to gate terminal of the transistor and configured to at least partly switch on the transistor while the diode is reverse biased and the level of the alternating input voltage reaches a clamping voltage.

2. The rectifier device of claim 1,
wherein the transistor is composed of a plurality of transistor cells, and
wherein, in order to partly switch on the transistor, the clamping circuit is configured to only switch on a first group of transistor cells of the plurality of transistor cells, while a second group of transistor cells remains off.

3. The rectifier device of claim 2,
wherein transistor cells of the first group are arranged in first segments of a semiconductor chip area and the transistor cells of the second group are arranged in second segments of the semiconductor chip area, the first and the second segments are arranged in the semiconductor chip in an alternating manner.

4. The rectifier device of claim 1,
wherein the clamping circuit includes at least one Zener diode coupled between the gate terminal and the cathode terminal of the transistor.

5. The rectifier device of claim 4,
wherein the transistor is a MOS transistor, the cathode terminal is a drain terminal of the MOS transistor, and the anode terminal is a source terminal of the MOS transistor.

6. The rectifier device according to claim 1,
wherein the control circuit is configured to detect the begin of the on-time period by detection that the diode has become conductive.

7. The rectifier device according to claim 1,
wherein the control circuit is configured to detect the begin of the on-time period by detecting that the voltage drop across the diode has reached a defined first threshold voltage.

8. The rectifier device according to claim 7,
wherein the control circuit is configured to detect the end of the on-time period by detecting that the voltage drop across the load current path of the first semiconductor switch has reached a defined second threshold voltage.

9. A rectifier device comprising:
a plurality of transistor cells integrated in a semiconductor body, a first group of transistor cells being assigned to a first transistor and a second group of transistor cells being assigned to a second transistor;
an anode and a cathode terminal, which are connected by load current paths of the first transistor and the second transistor;
a diode arranged in the semiconductor body between the anode and the cathode terminal;
a clamping circuit arranged in the semiconductor body and coupled between a gate terminal of the first transistor and the cathode terminal; and
wherein transistor cells of the first group are arranged in first segments of a semiconductor body and the transistor cells of the second group are arranged in second segments of the semiconductor body.

10. The rectifier device of claim 9,
wherein the first segments and the second segments are arranged in the semiconductor body in an alternating manner.

11. The rectifier device of claim 9,
wherein the area of the first segments is smaller than the area of the second segments.

12. The rectifier device of claim 9,
wherein the clamping circuit includes a Zener diode, through which a Zener current passed from the first load terminal to the gate terminal of the first transistor when a voltage between the cathode terminal and the anode terminal reaches a clamping voltage.

13. The rectifier device of claim 9, further comprising:
a control circuit integrated in the semiconductor body and configured to detect when the diode is forward biased and to switch on the first and the second transistor, subsequently or simultaneously, upon detection that the diode is forward biased.

14. The rectifier device of claim 9, further comprising:
a control circuit integrated in the semiconductor body and configured to switch of the first and the second transistor, subsequently or simultaneously, before the diode becomes reverse biased.

15. The rectifier device of claim 9,
wherein the clamping circuit is configured to activate the first transistor when a voltage between the cathode and the anode terminal reaches a clamping voltage.

16. The rectifier device of claim 15,
wherein the clamping circuit includes a Zener diode having a Zener voltage with a positive temperature coefficient, the clamping voltage depending on the Zener voltage.

17. The rectifier device of claim 9,
wherein the clamping circuit is configured to activate the first transistor when a voltage between the cathode and the anode terminal reaches a clamping voltage, and
wherein the area of the first segments is so small that, during the first transistor is activated for clamping, the first transistor is operated in a thermally stable state.

18. A method for operating a rectifier device, which comprises
a first transistor and a second transistor and a diode coupled in parallel between an anode terminal and a cathode terminal;
the method comprising:
detecting when the diode is forward biased and switching on the first and the second transistor upon detection that the diode is forward biased, and switching off the first and the second transistor before the diode becomes again reverse biased;
monitoring, by a clamping circuit, a voltage between the cathode terminal and the anode terminal, and
switching on the first transistor, when the diode is reverse biased and the voltage between the cathode terminal and the anode terminal reaches a clamping voltage, while the second transistor remains off.

19. A rectifier bridge comprising
a plurality of rectifier devices, each having:
an anode terminal and a cathode terminal;
a transistor having a load current path and a diode connected parallel to the load current path between the anode terminal and the cathode terminal; an alternating input voltage is operably applied between the anode terminal and the cathode terminal;
a control circuit that is coupled to a gate terminal of the transistor and configured to switch the semiconductor switch on for an on-time period, during which the diode is forward biased,
a clamping circuit coupled to gate terminal of the transistor and configured to at least partly switch on the transistor while the diode is reverse biased and the level of the alternating input voltage reaches a clamping voltage.

20. The rectifier bridge of claim 19,
wherein, for each rectifier device, the transistor is composed of a plurality of transistor cells, and
wherein, in order to partly switch on the transistor, the clamping circuit is configured to only switch on a first group of transistor cells of the plurality of transistor cells, while a second group of transistor cells remains off.

21. The rectifier bridge of claim 19,
wherein, for each rectifier device, the clamping circuit is configured to provide a clamping voltage with a positive temperature coefficient.
